(19) United States
(12) Patent Application Publication
(10) Pub. No.: US 2013/0263502 A1
(43) Pub. Date: Oct. 10, 2013

(54) Formulations for watering plants

(71) Applicant: Malcolm O'Shea, Newton Linford (GB)

(72) Inventor: Malcolm O'Shea, Newton Linford (GB)

(21) Appl. No.: 13/857,157

(22) Filed: Apr. 5, 2013

(30) Foreign Application Priority Data
Apr. 5, 2012 (GB) 1206183.4

(51) Int. Cl. B01J 20/24; A01G 27/00

(52) U.S. Cl. CPC B01J 20/24; A01G 27/00
USPC 47/48.5; 252/194

(57) ABSTRACT

A formulation for preparing a hydrogel for watering plants includes carboxymethyl cellulose and a dispersant. The dispersant disperses the carboxymethyl cellulose on addition of water thereby preventing formation of aggregates. The dispersant can be vermiculite, perlite, pectin, maltodextrin, guar gum, xanthan gum, or seaweed extract. A hydrogel for watering plants can be prepared by adding water to the formulation and mixing, and a method of forming the hydrogel is described. A pouch for watering plants contains the formulation and, when opened, water is added to form the hydrogel. A pot containing a plant in a plant-supporting matrix is placed in the pouch.

### CROSS-REFERENCE TO RELATED APPLICATIONS

This application claims the benefit of U.K. Patent Application No. GB1206183.4, filed Apr. 5, 2012.

### BACKGROUND OF THE INVENTION

The present invention relates to formulations for watering plants, in particular to formulations containing carboxymethyl cellulose, and for plants growing in containers, such as pots and the like.

A problem associated with growing plants in pots and containers of any type is how to keep them watered and in good condition whilst on holiday or away from home. Another problem is that plants grown in pots or containers are more susceptible to damage through neglect than plants grown in the ground. People forget to water and feed plants through being too busy, or alternatively they over water, which results in waterlogging.

One approach to solving the problem is a gel comprising carboxymethyl cellulose, which is particularly suited for plants in a soil-free culture and degrades on contact with micro-organisms in the environment to release water. The gel may additionally contain nutrient materials. The ingredients are provided in the hydrated gel form, and as such the gel is prone to premature degradation before use. Biocides can be added, but these act to reduce breakdown of the gel by microbial action when in use. Supply of a dry formulation, which would be resistant to microbial breakdown when dry due to the absence of water, is therefore desirable. However, when water is added to carboxymethyl cellulose, it tends to form lumps unless a mechanical stirrer is used.

### BRIEF SUMMARY OF THE INVENTION

A formulation for preparing a hydrogel for watering plants is provided, which comprises carboxymethyl cellulose and a dispersant. The dispersant disperses the carboxymethyl cellulose on addition of water thereby preventing formation of aggregates. The formulation may comprise vermiculite, perlite, pectin, maltodextrin, guar gum, xanthan gum and/or seaweed extract.

A method of preparing a hydrogel for watering plants is also provided, and comprising the steps of: providing a dry formulation comprising carboxymethyl cellulose and dispersant; adding water to the dry formulation to form a mixture; and stirring the mixture to form a hydrogel. The dispersant promotes hydrogel formation thereby preventing formation of aggregates of carboxymethyl cellulose.

A hydrogel for watering plants growing in a plant-supporting matrix is also provided, the hydrogel comprising carboxymethyl cellulose, a dispersant and water, wherein microorganisms in the plant-supporting matrix degrade the carboxymethyl cellulose, releasing the water.

A pouch for watering plants comprising the formulation disclosed above is also provided, and wherein, when opened, water is added to the formulation to form a hydrogel and a pot containing a plant in a plant-supporting matrix is placed in the pouch.

### BRIEF DESCRIPTION OF THE SEVERAL VIEWS OF THE DRAWING

FIG. 1 shows a plant growing in a plant-supporting matrix in a pot surrounded by a pouch containing a hydrogel.

### DETAILED DESCRIPTION OF THE INVENTION

The formulation for preparing a hydrogel for watering plants comprises carboxymethyl cellulose and dispersant. These ingredients can be dry mixed.

The dispersant is a material which disperses the carboxymethyl cellulose on addition of water, thereby preventing aggregation. These are particularly suitable to mix with carboxymethyl cellulose to produce a hydrogel immediately, as carboxymethyl cellulose used on its own goes into lumps and has to be mixed with a mechanical stirrer or liquidiser, which is not practical.

Dispersants include vermiculite, perlite, pectin, maltodextrin, guar gum, xanthan gum, or seaweed extract, either or alone or in combination.

A formulation for preparing a hydrogel comprising carboxymethyl cellulose and vermiculite can contain 2 to 16 g of carboxymethyl cellulose and 1 to 8 g of vermiculite. Preferably, the formulation can contain 4 to 12 g of carboxymethyl cellulose and 2 to 6 g of vermiculite. This formulation is mixed with 400 ml of water to form a hydrogel. The vermiculite can be, for example, grade VO from Silvaperl®.

A formulation for preparing a hydrogel comprising carboxymethyl cellulose and perlite can contain 2 to 16 g of carboxymethyl cellulose and 0.5 to 3.5 g of perlite. Preferably, the formulation can contain 4 to 12 g of carboxymethyl cellulose and 1 to 2.5 g of perlite. This formulation is mixed with 400 ml of water to form a hydrogel. The perlite can be, for example, grade P10 from Silvaperl® which is a fine grade.

Carboxymethyl cellulose is biodegradable by micro-organisms in the environment, and in particular micro-organisms in the plant-supporting matrix (soil, compost and the like) used in the pot for growing the plant. When degraded and respired, water is released.

Advantageously, the dry formulation has enhanced stability because the carboxymethyl cellulose cannot be degraded by mirco-organsims until it is hydrated.

Where the formulation comprises seaweed extract, it provides nutrient for the plant.

For use, water is added to the formulation and the mixture stirred to form a hydrogel. The amount of carboxymethyl cellulose in the hydrogel can be varied by adjusting the amount of water added to produce a hydrogel of the desired viscosity or stiffness: for a stiff hydrogel a smaller amount of water is added than for a less stiff, more runny, hydrogel. If the hydrogel is jelly-like it lasts longer than when it is runny as it just soaks straight through the compost too quickly.

Alternatively, the hydrogel comprises carboxymethyl cellulose and dispersant, to be used in any type or form of container. The gel would be made up by a producer or distributor of pot plants for stores and supermarkets, for example, for watering plants on display. Thus the producer or distributor would apply the hydrogel to a plant-supporting matrix, choosing an amount of hydrogel according to a period of time the plant is to remain on display before purchase. The amount can be in the range of 100 to 260 ml, and the period of time is in the range of 7 to 14 days. The amount to be used to produce a gel with carboxymethyl cellulose and dispersant is typically 1 litre water and 20 grams carboxymethyl cellulose which can be varied either way according to how stiff or runny the gel is required, as described previously. The amount to be used to produce a gel with carboxymethyl cellulose plus dispersant will vary according to how long the retailer requires the pot plant to last on display: typically for 7 days this might be 100 ml gel per plant, for 10 days 160 mL, and for 14 days 260 ml, provided the plant is watered well first.

In order that the hydrogel can break down back into water by bacterial action, it must be in contact with the plant-supporting matrix. There are various ways to achieve this, for example, the hydrogel can be is poured onto the plant-supporting material of a pot plant, or more advantageously, into a container such as a normal pot cover without holes in the bottom, sufficient in size to leave enough space around the sides for the hydrogel to ooze up around the sides of the plastic pot containing the plant without overflowing over the top of the pot cover. The hydrogel is then in contact with the compost through the holes in the bottom of the pot the plant is potted into, and so in turn gradually breaks down into water and is then taken up by the plant by normal capillary action.

The formulation can be packed into pouches, each pouch containing an amount of the formulation sufficient to be able to maintain a plant growing in a pot whilst the owner is absent or busy.

When opened water can be added to the pouch and the mixture stirred to form the hydrogel.

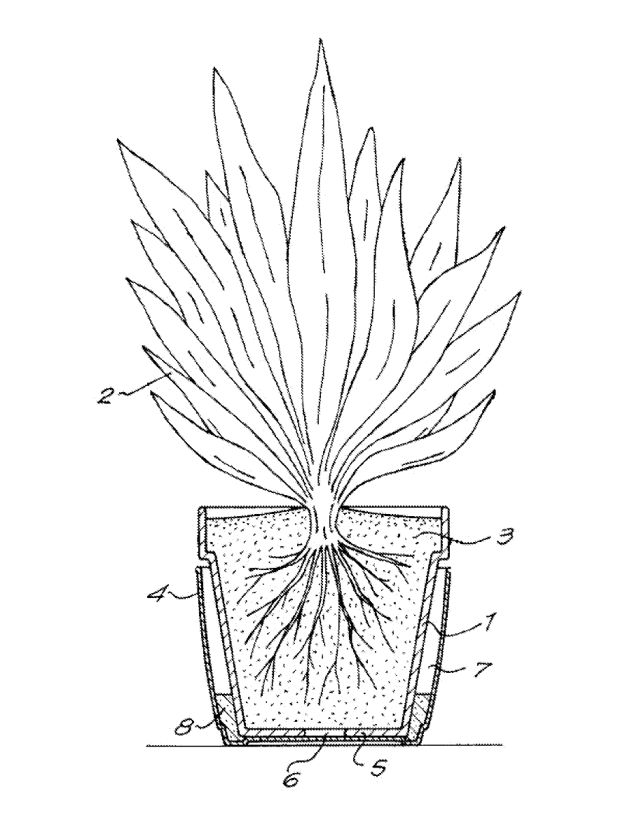

FIG. 1 shows the opened pouch 4 arranged around a pot 1 containing plant 2 growing in a plant-supporting matrix 3. Plant-supporting matrix 3 can be for example soil, compost or other medium.

Pot 1 can be comprised of a material permeable to water, such as, for example burnt clay, or it can comprise a material impermeable to water, such as, for example, a plastic. In the latter case pot 1 has one or more holes 6 in which the plant 2 is put together with the required earth 3.

Pouch 4 comprises a material impermeable to water, such as, for example, plastic.

Pot 1 rests with its lower part 5 on the bottom 6 of pouch 4, such that a space 7 is formed between pot 1 and pouch 4.

Hydrogel 8 formed in the bottom of the opened pouch at least partially fills the space 7. The hydrogel is drawn by capillarity into the pot containing the plant-supporting matrix and the plant, whereupon the hydrogel is slowly degraded by micro-organisms present in the plant-supporting matrix, releasing water into the matrix for use by the plant.

A suitable preparation of carboxymethyl cellulose, which is 99.5% pure carboxymethyl cellulose and 0.75 up to 0.95 degree of solution, is available from CP Kelco®.

A suitable preparation of seaweed extract is Algifert K, which is available from Maxicrop UK Ltd of Corby. After drying and grinding the seaweed, it is hydrolysed to obtain Betaines from the cell walls, and plant sugars and other compounds are extracted. This extract is 100% soluble and facilitates formation of carboxymethyl cellulose hydrogel. It also has some feed value to a plant.

To prepare a litre of hydrogel, the dry formulation can contain 20 g of carboxymethyl cellulose and 10 g of seaweed extract, and this gives a useful hydrogel stiffness. This can be packed dry at the rate of 8 grams of carboxymethyl cellulose to a pouch plus 4 grams of seaweed extract. 400 ml of water can be poured into the pouch to produce a stiff gel. This would be suitable for a plant growing in a 10-15 cm diameter pot, and would provide water for at least two weeks, depending on the temperature and other environmental factors.

To prepare a less stiff hydrogel, the dry formulation can contain 20 grams carboxymethyl cellulose to 5 grams of seaweed extract. Other variations are possible, but in general, it is better to use a stiffer mix as it lasts longer, a runny mix will just soak through the compost like watering.

Water-logging is thus prevented by use of the CMC and dispersant as a normal method of watering; instead of watering every few days the plants only need watering every two to three weeks using the gel, which can be replenished as needed.

1. A formulation for preparing a hydrogel for watering plants, said formulation comprising:
carboxymethyl cellulose and a dispersant wherein said dispersant disperses said carboxymethyl cellulose on addition of water thereby preventing formation of aggregates.

2. The formulation of claim 1, wherein said dispersant comprises one or more of: vermiculite, perlite, pectin, maltodextrin, guar gum, xanthan gum, or seaweed extract.

3. A method for preparing a hydrogel for watering plants, said method comprising the steps of:
providing the formulation of claim 1 in a dry form, said formulation comprising carboxymethyl cellulose and dispersant;
adding water to said dry formulation to form a mixture;
stirring said mixture to form a hydrogel;
wherein said dispersant promotes hydrogel formation thereby preventing formation of aggregates of carboxymethyl cellulose.

4. The method of claim 3, wherein said dispersant comprises one or more of: vermiculite, perlite, pectin, maltodextrin, guar gum, xanthan gum, or seaweed extract.

5. A pouch for watering plants comprising the formulation of claim 1, and wherein, when opened, water is added to said formulation to form a hydrogel and a pot containing a plant in a plant-supporting matrix is placed in said pouch.

6. The pouch of claim 5, wherein said dispersant comprises one or more of: vermiculite, perlite, pectin, maltodextrin, guar gum, xanthan gum, or seaweed extract.

7. A hydrogel for watering plants growing in a plant-supporting matrix, said hydrogel comprising carboxymethyl cellulose and water, wherein microorganisms in said plant-supporting matrix degrade said carboxymethyl cellulose, releasing said water, and wherein said hydrogel additionally comprises a dispersant.

8. The hydrogel of claim 7, wherein said dispersant comprises one or more of: vermiculite, perlite, pectin, maltodextrin, guar gum, xanthan gum, or seaweed extract.

9. A method for watering plants on display comprising the steps of:
providing a plant growing in a plant-supporting matrix in a pot;
applying the hydrogel of claim 8 to said plant-supporting matrix;
wherein an amount of said hydrogel is chosen according to a period of time said plant is to remain on display before purchase.

10. The method of claim 9, in which said amount is in the range of 100 to 260 ml, and said period of time is in the range of 7 to 14 days.
